(19) United States
(12) Patent Application Publication
(10) Pub. No.: US 2008/0028094 A1
(43) Pub. Date: Jan. 31, 2008

(54) METHOD AND SYSTEM FOR SERVICING BGM REQUEST AND FOR PROVIDING SOUND SOURCE INFORMATION

(75) Inventor: CHAN JIN KANG, SEOUL (KR)

Correspondence Address: KNOBBE MARTENS OLSON & BEAR LLP, 2040 MAIN STREET, FOURTEENTH FLOOR, IRVINE, CA, 92614, US

(73) Assignee: WIDERTHAN CO., LTD., SEOUL (KR)

(21) Appl. No.: 11/831,212

(22) Filed: Jul. 31, 2007

(30) Foreign Application Priority Data
Jul. 31, 2006 (KR) 10-2006-0072162
Aug. 3, 2006 (KR) 10-2006-0079150

(51) Int. Cl. G06F 15/16

(52) U.S. Cl. 709/231

(57) ABSTRACT

A system and method for providing music source information of a service to play a background music (BGM) source in a real time streaming manner in a corresponding member store since related contents to BGM source information is provided, and a request for the BGM source is made via the user terminal, is provided. The method includes: maintaining a music source information database which stores a member store identifier, with respect to at least one member store, and BGM source information which corresponds to the member store identifier, the BGM source information including playlist information of a BGM source to be played in the member store; receiving the member store identifier from a user terminal via a wired/wireless communication network; reading the BGM source information which corresponds to the member store identifier by referring to the music source information; and transmitting the BGM source information to the user terminal.

### CROSS-REFERENCE TO RELATED APPLICATIONS

This application claims the benefit of Korean Patent Application No. 10-2006-072162, filed on Jul. 31, 2006, and of Korean Patent Application No. 10-2006-079150, filed on Aug. 3, 2006, in the Korean Intellectual Property Office, the disclosure of both of which are incorporated herein by reference.

### BACKGROUND OF THE INVENTION

1. Field of the Invention

The present invention relates to a system for providing music source information and a method using the system, and more particularly, to a system and method for providing music source information which provides related contents with respect to background music (BGM) source of a member store, makes a request for a BGM source via the user terminal, and plays the BGM source in a real time streaming manner in a corresponding member store.

2. Description of Related Art

Conventionally, music sources are provided by directly purchasing discs in an offline member store, or provided by selecting a music source to transmit from a music source service provider via an Internet peer to peer (P2P) solution or an Internet streaming site. The above described methods have disadvantages in that an owner of the member store is required to select a background music (BGM) source, and there is a possibility of violating copyrights of the BGM source. Also, there is another method that outputting a BGM source, which is previously selected by a member having joined in a jukebox terminal, via an audio speaker. In this case, costs for establishment and maintenance are additionally required since an owner of the member store is required to additionally purchase a jukebox terminal.

Also, a user who uses a conventional offline member store is unable to immediately inquire about a BGM source presently being listened to since the user is required to acquire an answer to a query about music source information regarding the BGM source beforehand, such as a song title, an artist, a produced year, and a playlist of the BGM source, to a manager of the member store, and remember the BGM source information.

Also, the user may be provided with related contents, such as data of ring sounds, which is related to the BGM source information of the member store via the user terminal when the user wants to receive data of the related contents, such as data of ring back tones, and data of artists corresponding to the BGM source information. That is, the user may not directly receive the BGM source information and the related contents with respect to the BGM source in a real time via the user terminal.

Consequently, the above described methods may not provide the user with a service capable of directly providing the BGM source.

### BRIEF SUMMARY

An aspect of the present invention provides a system and method for providing a user terminal with music source information which receives a member store identifier from a user, and transmits BGM source information of a member store or related contents to the BGM source information to the user terminal.

An aspect of the present invention also provides a system and method for providing a user terminal with music source information which can immediately respond to a query regarding a music source which is presently being listened to by a user in a member store by receiving BGM source information, which is being outputted to each member store in real time via a user terminal, and can simultaneously transmit related contents of the BGM source information to the user terminal.

An aspect of the present invention also provides a system and method for providing a user terminal with music source information which can make a request for a BGM source via the user terminal, and can play the BGM source in a real time streaming manner in a corresponding member store.

An aspect of the present invention also provides a system for providing a user terminal with music source information which can make a query for a BGM source, which is selected and being played for each member store, via the user terminal.

An aspect of the present invention also provides a system and method for providing a user terminal with music source information which can produce a suitable ambience for each member store since a request for a BGM source may be made via the user terminal in each member store, and the requested BGM source may be provided to the each member store according to categories of the BGM source.

An aspect of the present invention also provides a system and method for providing a user terminal with music source information which can produce a suitable ambience for each member store since a request for a BGM source is made via the user terminal for each member store, and the requested BGM source is received according to categories of the BGM source.

An aspect of the present invention also provides a system and method for providing a user terminal with music source information which can produce a suitable ambience according to a user's feeling since the user's required comment is inserted into a BGM source via the user terminal, and the BGM source selected by the user is listened to in a real time streaming manner via an audio system in a member store.

An aspect of the present invention also provides a system and method for providing a user terminal with music source information which can provide a differentiated ubiquitous service capable of connecting an online and an offline member store since a BGM source is requested via the user terminal, and the requested BGM source is played in a corresponding member store in a real time streaming manner.

According to an aspect of the present invention, there is provided a method for providing a user terminal with music source information including: maintaining a music source information database which stores a member store identifier, with respect to at least one member store, and background music (BGM) source information which corresponds to the member store identifier, the BGM source information including playlist information of a BGM source to be played in the member store; receiving the member store identifier from a user terminal via a wired/wireless communication network; reading the BGM source information which corresponds to the member store identifier by referring to the music source information; and transmitting the BGM source information to the user terminal.

According to another aspect of the present invention, there is provided a system for providing a user terminal with music source information including: a music source information database storing a member store identifier, with respect to at least one member store, and BGM source information which corresponds to the member store identifier, the BGM source information including playlist information of a BGM source to be played in the member store; a member store identifier receiving module receiving the member store identifier via a wired/wireless communication network from a user; a music source information management module outputting the BGM source information which corresponds to the member store identifier by referring to the music source information database; and a music source information transmission module transmitting the BGM source information to a user terminal.

According to still another aspect of the present invention, there is provided a method of providing a service with respect to a request for a BGM source including: maintaining a music source information database which stores a member store identifier, with respect to at least one member store, and BGM source information which corresponds to the member store identifier, the BGM source information including playlist information of a BGM source to be played in the member store; receiving the member store identifier from a user terminal via a wired/wireless communication network; receiving requested BGM source information; updating the BGM source information stored in the music source information database according to the requested BGM source information.

According to yet another aspect of the present invention, there is provided a method of providing a service with respect to a request for a BGM source information including: receiving required BGM source information to play in a member store from at least one member store, and storing the BGM source information in a music source information database, the BGM source information including playlist information of the BGM source to play in the member store; receiving the member store identifier from a user terminal via a wired/wireless communication network; receiving requested BGM source information from the user terminal; and updating the BGM source information stored in the music source information database according to the requested BGM source information.

According to a further another aspect of the present invention, there is provided a system for providing a service to play a BGM source in a real time streaming manner in a corresponding member store by making a request for the BGM source via a user terminal including: a music source information database storing a member store identifier, with respect to at least one member store, and BGM source information which corresponds to the member store identifier, the BGM source information including playlist information of the BGM source to be played in the member store; a member store identifier management module receiving the member store identifier from a user via a wired/wireless communication network, and transmitting the member store identifier to the user terminal; a music source information management module outputting the BGM source information which corresponds to the member store identifier by referring to the music source information, and transmitting the BGM source information to the user terminal; and a music source selection providing module selecting the BGM source of a music source being required by the member store from the music source information database, and selecting a requested BGM source which is requested by a user.

The user terminal in the specification of the present invention is a general concept of a communication terminal that can include a predetermined communication module such as, a Code Division Multiplexing Access (CDMA) module, a Bluetooth module, an infrared data association (IrDA) module, and a wired/wireless LAN card, such as those included in a personal computer, a personal digital assistant (PDA), a smart phone, a handheld PC, and a mobile phone. Also, the user terminal may include a microprocessor which can play multimedia and perform a certain calculation operation.

Additional aspects, features, and/or advantages of the invention will be set forth in part in the description which follows and, in part, will be apparent from the description, or may be learned by practice of the invention.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a configuration of a system for providing a service with respect to BGM source information of a member store, for either providing a service with respect to related contents of the BGM source information via a user terminal, or implementing a service which is performed in a corresponding member store by requesting the BGM source via the user terminal, according to an exemplary embodiment of the present invention.

FIG. 2 is a block diagram illustrating a configuration of a system for providing music source information which makes a request for a BGM source, and provides a play service in a real time streaming manner in a corresponding member store according to an exemplary embodiment of the present invention;

FIG. 3 is a block diagram illustrating a configuration of a system for providing music source information according to another exemplary embodiment of the present invention;

FIG. 4 is a flowchart illustrating a method for providing a service with respect to a request for a BGM source, which is requested to be played in a corresponding member store, according to an exemplary embodiment of the present invention;

FIG. 5 is a flowchart illustrating a method providing a service with respect to a request for a BGM source via a user terminal according to an exemplary embodiment of the present invention;

FIG. 6 is a flowchart illustrating a method for providing a service with respect to a request for a BGM source, the BGM source being requested via a user terminal and being played in a corresponding member store, according to an exemplary embodiment of the present invention;

FIG. 7 is a flowchart illustrating a method for providing BGM source information according to another exemplary embodiment of the present invention;

FIGS. 8A through 8D are diagrams illustrating operations of being provided with either music source information in a user terminal, or related contents with respect to the music source information, according to another exemplary embodiment of the present invention; and

FIG. 9 is a flowchart illustrating a system for providing music source information which provides a user terminal with BGM source information of a member store, or provides related contents with respect to the BGM source information according to another exemplary embodiment of the present invention.

### DETAILED DESCRIPTION OF EMBODIMENTS

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

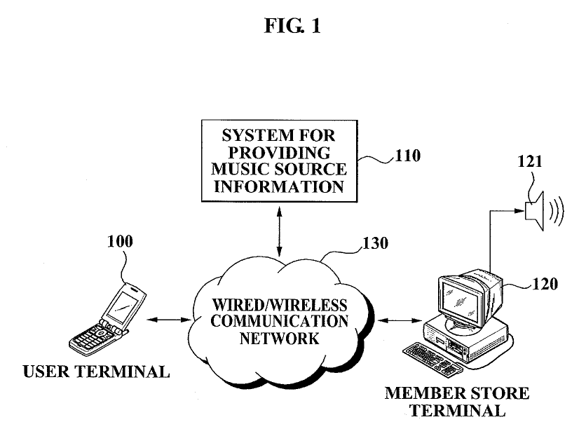

FIG. 1 is a diagram illustrating a configuration of a system for providing a service with respect to BGM source information of a member store, for either providing a service with respect to related contents of the BGM source information via a user terminal, or implementing a service which is performed in a corresponding member store by requesting the BGM source via the user terminal, according to an exemplary embodiment of the present invention.

Referring to FIG. 1, the system for providing the service with respect to BGM source information comprises a system 110 for providing music source information via a wired/wireless communication network 130 in order to receive BGM source information and related contents with respect to the BGM source information. A member store is connected with the system 110 for providing music source information to receive the requested BGM source via the wired/wireless communication network 130. Also, a speaker 121 in the member store is connected with a member store terminal 120 to output the BGM source which is received from the member store terminal 120.

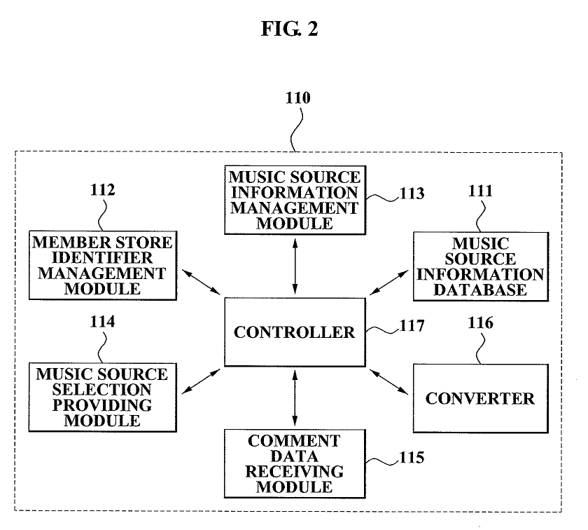

FIG. 2 is a block diagram illustrating a configuration of a system 110 for providing music source information which makes a request for a BGM source, and provides a play service in a real time streaming manner in a corresponding member store according to an exemplary embodiment of the present invention.

Referring to FIG. 2, the system 110 for providing music source information according to the exemplary embodiment of the present invention includes a music source information database 111, a member store identifier management module 112, a music source information management module 113, a music source selection providing module 114, a comment data receiving module 115, and a converter 116.

The source information database 111 stores BGM source information which corresponds to a member store identifier, with respect to at least one member store, and BGM source information which corresponds to the member store identifier. The member store identifier may be made of consecutive numerals or characters of the member store, in which a music source is provided from the system 110 for providing music source information, and the BGM source information may include playlist information of a BGM source to be played in the member store.

The member store identifier management module 112 receives the member store identifier from a user terminal 100, or transmits the member store identifier to the user terminal 100, via a wired/wireless communication network 130. The music source information management module 113 outputs the BGM source information which corresponds to the member store identifier, or transmits the BGM source information to the user terminal 100 by referring to the music source information database 111. The music source selection providing module 114 selects a BGM of a music channel to play in the member store from the music source information database 111, or provides a music source selection menu in order to enable selecting of a BGM source required by a user. Also, the comment data receiving module 115 receives comment data to be inserted into the requested BGM source from the user terminal 100, and the converter 116 transmits the comment data in a streaming manner, and converts the comment data to a speech file which is inserted to the requested BGM source.

The system 110 for providing music source information according to the embodiment of the present invention may further include a payment control module (not shown) capable of controlling a predetermined payment system to pay for the related contents when a purchase request for the related contents exists, from the user. Also, the system 110 for providing music source information according to the embodiment of the present invention may further include a controller 117 to control each module for smooth transmission/reception of a signal between each module in the system 110 for providing music source information. By using the above described configuration, a BGM source may be requested via a user terminal, the BGM source may be played in a real time streaming manner in a member store, and a differentiated ubiquitous service capable of connecting an online and an offline member store may be provided by using a method for providing a service with respect to the BGM request and the system for providing the music source information.

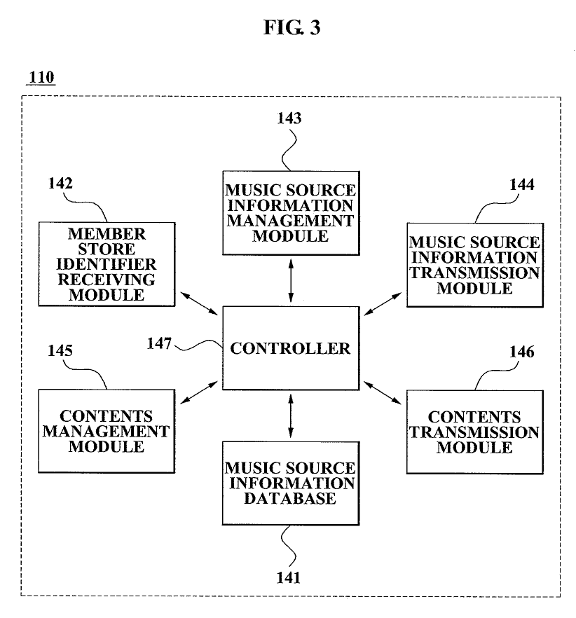

FIG. 3 is a block diagram illustrating a configuration of a system 110 for providing music source information according to another exemplary embodiment of the present invention.

Referring to FIG. 3, the system 110 for providing music source information according to an exemplary embodiment of the present invention includes a music source information database 141, a member store identifier receiving module 142, a music source information management module 143, and a music source information transmission module 144.

The music source information database 141 stores a member store identifier, with respect to at least one member store, and BGM source information which corresponds to the member store identifier, and the member store identifier may be made of consecutive numerals and characters of the member store, in which a music source is provided from the system 110 for providing music source information. The BGM source information includes playlist information of a BGM source to be played in the member store.

The member store identifier receiving module 142 receives the member store identifier from the user terminal 100 via a wired/wireless communication network 130, the music source information management module 143 transmits the BGM source information which corresponds to the member store identifier by referring to the music source information database 141, and the music source information transmission module 144 transmits the outputted BGM source information to the user terminal 100.

The system 110 for providing music source information according to the exemplary embodiment of the present invention may further include a contents management module 145, a contents transmission module 146, and a payment control module (not shown).

The contents management module 145 receives a request signal for related contents of the BGM source information transmitted from a user. Also, the contents transmission module 146 transmits the related contents, which are transmitted from the user, to the user terminal 100. Also, the contents transmission module 146 may provide address information to enable the related contents to be used in the user terminal 100. The related contents may be any one of a BGM source file which corresponds to the BGM source information, data of ring sounds which corresponds to the BGM source information, data of ring back tones which corresponds to the BGM source information, and data about artists which corresponds to the BGM source information. The payment control module (not shown) controls a predetermined payment system to pay for the related contents when a purchase request for the related contents exists, from the user.

Also, the system 110 for providing music source information may further include a controller 147 to control each module for smooth transmission/reception of a signal between each module in the system 110 for providing music source information.

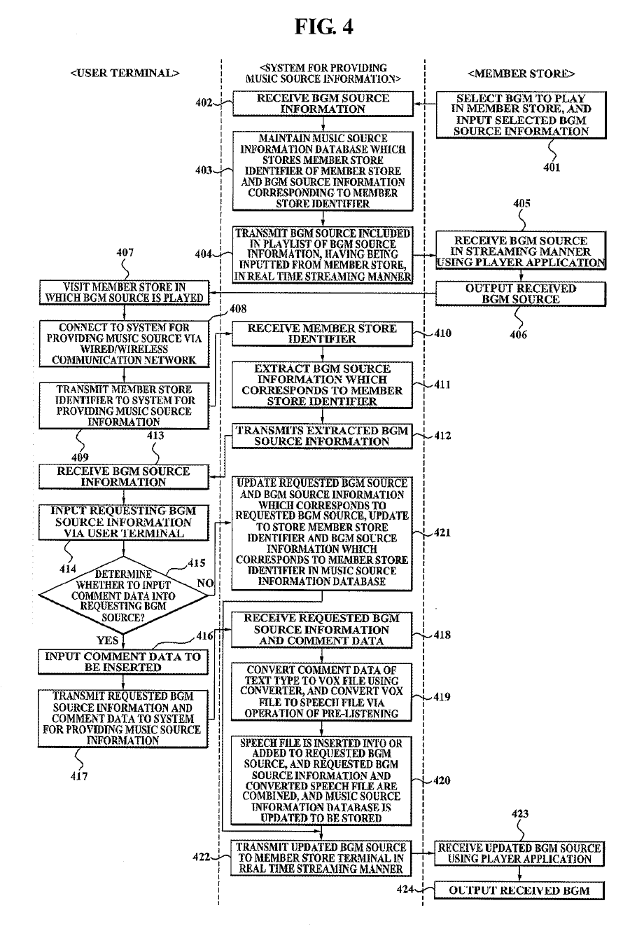

FIG. 4 is a flowchart illustrating a method for providing a service with respect to a request for a BGM source, which is requested to be played in a corresponding member store, according to an exemplary embodiment of the present invention.

Referring to FIG. 4, in operation 401, a member store selects a music channel, that is, a BGM, and inputs selected BGM source information to play the BGM in the member store. The inputting of the selected BGM source information may be performed via a member store terminal 120 via a wired/wireless communication network, and the BGM source information includes playlist information of a BGM source to be played in the member store. The wired/wireless communication network supports a wireless application protocol (WAP) or the World Wide Web (WEB). The system 110 for providing music source information receives the BGM source information in operation 402, and maintains a music source information database which stores a member store identifier of the member store and the BGM source information corresponding to the member store identifier in operation 403. The member store identifier is a combination of consecutive numerals and characters, which are allocated to the member store, and is stored in the music source information database for each member store.

The system 110 for providing music source information transmits a BGM source included in the playlist of the BGM source information, having being inputted from the member store, in a real time streaming manner in operation 404, and the member store receives the BGM source in a streaming manner using a player application in operation 405. The member store outputs the received BGM source to the speaker 121 inside the member store via the member store terminal 120, in operation 406. As described above, each member store may produce a suitable ambience for each member store since each member store receives the BGM source via the member store terminal 120, by using a connection with audio equipment in the member store.

In operation 407, the user visits a member store, in which the BGM source is received from the system 110 for providing music source information and is played. In operation 408, the user connects to the system 110 for providing music source via the wired/wireless communication network 130 by using the user terminal 100 to make a request for a required BGM source. The user transmits a member store identifier to the system 110 for providing music source information via the user terminal 100 in operation 409. The system 110 for providing music source information receives the member store identifier in operation 410, and extracts BGM source information which corresponds to the member store identifier in operation 411. The system 110 for providing music source information transmits the extracted BGM source information in operation 412, and the user terminal 100 receives the BGM source information in operation 413. The user may identify a playlist of a BGM source which is being played in the member store using the received BGM source information, and identify selected BGM source information, for example, volume, selecting times, whether a BGM source requested by the user is included in the playlist, and the like.

In operation 414, the user inputs requested BGM source information via the user terminal 100. The requested BGM source information includes comprehensive information, such as selecting times and volumes of a requested BGM source, and the like. In operation 415, the user determines whether to insert comment data into the requested BGM source. When the comment data is not inserted into the requested BGM source, the system 110 for providing music source information updates the requested BGM source and BGM source information which corresponds to the requested BGM source, updates to store the member store identifier and BGM source information which corresponds to the member store identifier in the music source information database in operation 421. The system 110 for providing music source information transmits the updated BGM source to the member store terminal 120 in a real time streaming manner in operation 422, and the member store receives the updated BGM source using a player application in operation 423, via the member store terminal 120. In operation 424, the member store outputs the received BGM source to the speaker 121 inside the member store via the member store terminal 120. As described above, each member store may produce a suitable ambience for the each member store since the each member store respectively receive a BGM source via the member store terminal 120, by using a connection with audio equipment in the member store.

When the comment data is inserted into the requested BGM source, the user inputs comment data to be inserted via the user terminal 100 in operation 416. The comment data may be text data, and may be speech data of the user.

In operation 417, the requested BGM source information and the comment data are transmitted to the system 110 for providing music source information via the user terminal 100. In operation 418, the system 110 for providing music source information receives the requested BGM source information and the comment data. A converter 116 of the system 110 for providing music source information converts the comment data of a text type to a voice operated transmitting (VOX) file, and converts the VOX file to a speech file, such as an MP3 file, via operation of pre-listening in operation 419. The speech file is inserted into or added to the requested BGM source, and the requested BGM source information and the converted speech file are combined, and the music source information database of the system 110 for providing music source information is updated to be stored in operation 420. In operation 422, according to the updated BGM source information, the system 110 for providing music source information transmits the updated BGM source to the member store terminal 120 in a real time streaming manner. The member store receives the updated BGM source via the member store terminal 120. Specifically, the member store receives the updated BGM source using a player application in operation 423. The member store outputs the received BGM source to the speaker 121 inside the member store via the member store terminal 120 in operation 424. According to the present invention, a user may insert a required comment into a BGM source via a user terminal, listen to the BGM source selected by the user via an audio system in real time in a member store, thereby producing a suitable ambience according to a user's feeling.

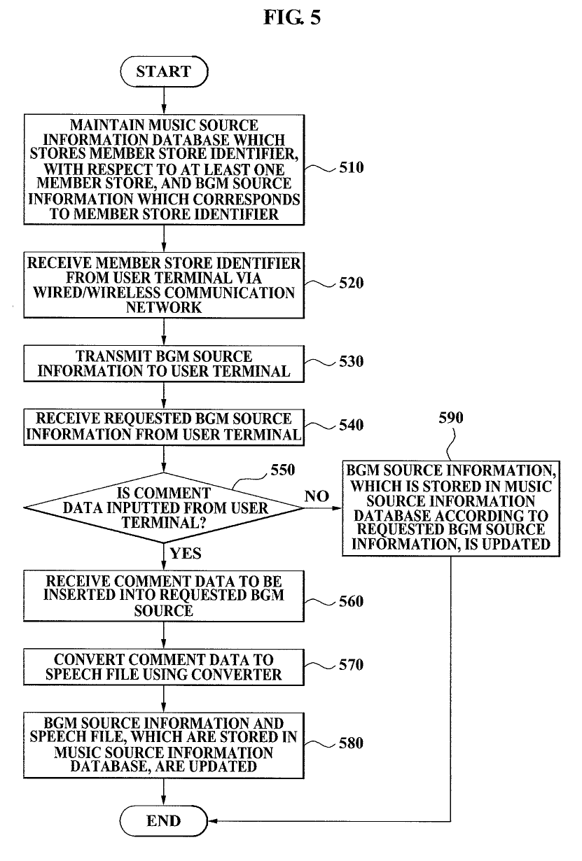

FIG. 5 is a flowchart illustrating a method providing a service with respect to a request for a BGM source via a user terminal according to an exemplary embodiment of the present invention.

Referring to FIG. 5, the system 110 for providing music source information maintains a music source information database which stores a member store identifier, with respect to at least one member store, and BGM source information which corresponds to the member store identifier in operation 510. The system 100 for providing music source information receives the member store identifier from the user terminal 100 via a wired/wireless communication network 130 in operation 520. The system 100 for providing music source information reads the BGM source information which corresponds to the member store identifier by referring to the music source information, and transmits the BGM source information to the user terminal 100 in operation 530. The system 100 may identify a playlist of the BGM source information which is outputted from a predetermined member store or a member store where the user has visited. The user identifies the BGM source information, selects a BGM source using the system 110 for providing music source information, transmits requested BGM source information, and receives the requested BGM source information from the user terminal in operation 540.

In operation 550, the user determines whether comment data, which will be inserted into the requested BGM source, is inputted from the user terminal 100. When the comment data is not inputted, BGM source information, which is stored in a music source information database according to the requested BGM source information, is updated in operation 590. The member store outputs the requested BGM source to the speaker 121 inside the member store, via the member store terminal 120.

When the comment data is inputted, the comment data to be inserted into the requested BGM source is received from the user terminal 100 in operation 560. The comment data includes a text data. In operation 570, the comment data is converted to a speech file using a converter. In operation 580, the requested BGM source information and the speech file are reflected, and the BGM source information and the speech file, which are stored in the music source information database, are updated. The member store outputs the requested BGM source to the speaker 121 inside the member store, via the member store terminal 120.

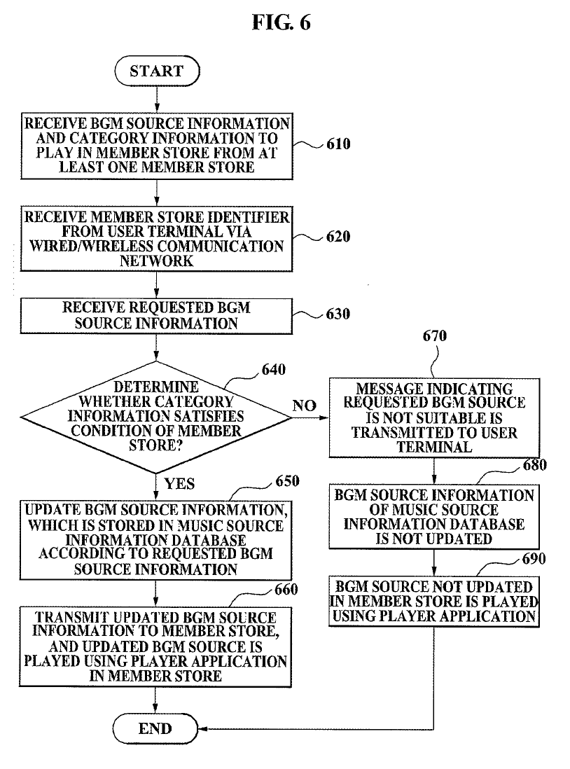

FIG. 6 is a flowchart illustrating a method for providing a service with respect to a request for a BGM source, the BGM source being requested via a user terminal and being played in a corresponding member store, according to an exemplary embodiment of the present invention.

Referring to FIG. 6, BGM source and category information to play in at least one member store are received in operation 610. The BGM source and category information may include types of BGM sources which are suitable for ambience of the member store. Specifically, the BGM source and category information may include music genres such as a dance, a ballad, rhythm & blues, and may be categorized as classical music, pop songs, Korean pop songs, and the like. A member store identifier is received from the user terminal 100 via a wired/wireless communication network in operation 620, and the user receives requested BGM source information from the user terminal after identifying a playlist of the member store in operation 630. The wired/wireless communication network supports a WAP or the World Wide Web (WEB), and the requested BGM source information includes volumes and selecting times of the requested BGM source.

In operation 640, it is determined whether a category of a music source including the requested BGM source satisfies a condition of the member store, the condition of the member store is that a music category associated with an ambience of the member store corresponds to the category of the music source. When a category of the requested BGM source does not satisfy the condition of the member store, a message indicating the requested BGM source is not suitable is transmitted to the user terminal 100 in operation 670, and the BGM source information of the music source information database is not updated in operation 680. That is, the BGM source, which has not been updated in the member store, is played using a player application in operation 690.

When the category of the requested BGM source satisfies the condition of the member store, the BGM source information, which is stored in the music source information database according to the requested BGM source information, is updated in operation 650. The updated BGM source information is transmitted to the member store, and the updated BGM source is played using the player application in the member store in operation 660. According to the method for providing music source information of the present invention, a BGM source is requested for each member store using a user terminal, a requested BGM source satisfying a condition of a category of a BGM source is exclusively received, thereby producing a suitable ambience for the member store.

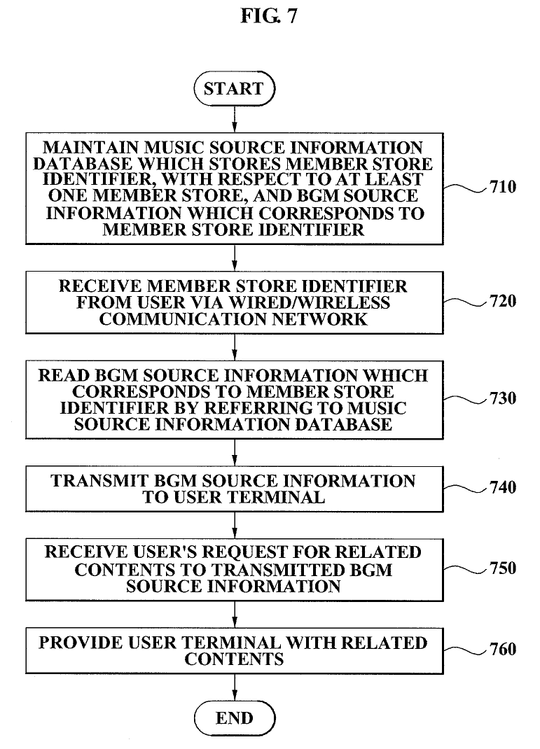

FIG. 7 is a flowchart illustrating a method for providing BGM source information according to another exemplary embodiment of the present invention.

Referring to FIG. 7, a music source information database which stores a member store identifier, with respect to at least one member store, and BGM source information which corresponds to the member store identifier is maintained in operation 710. In this instance, the BGM source information includes a playlist of the BGM source which is played in the member store. The member store identifier is received from a user via a wired/wireless communication network in operation 720, and the BGM source information which corresponds to the member store identifier by referring to a music source information database is read in operation 730. The wired/wireless communication network supports a WAP or a WEB. The BGM source information is transmitted to the user terminal in operation 740, and a user's request for related contents to the transmitted BGM source information is received in operation 750. In operation 760, the transmitted contents are provided to the user terminal. In this instance, address information enabling the related contents to be used in the user terminal may be provided as the related contents. Also, the related contents includes any one of a BGM source file which corresponds to the BGM source information, data of ring sounds corresponding to the BGM source information, data of ring back tones which corresponds to the BGM source information, and data about artists which corresponds to the BGM source information.

The method for providing BGM source information according to the present invention may further include an operation of controlling a predetermined payment system to pay for the related contents when a purchase request for the related contents exists, from the user.

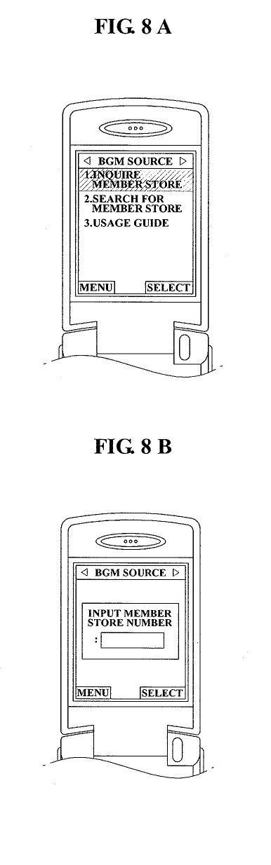

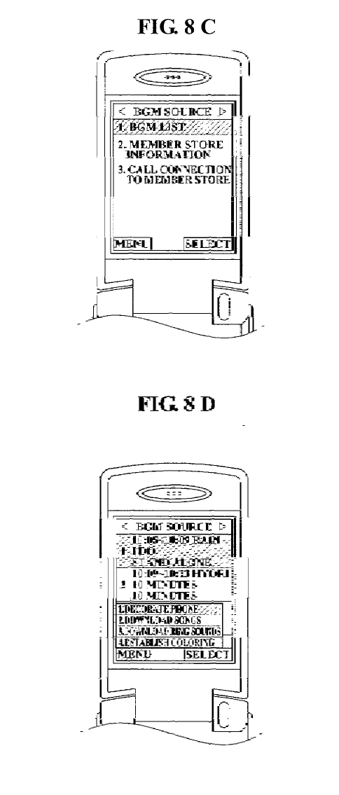

FIGS. 8A through 8D are a diagrams illustrating operations of being provided with either music source information in a user terminal, or related contents with respect to the music source information, according to another exemplary embodiment of the present invention.

Referring to FIGS. 8A through 8D, a menu for function selection may be additionally provided in a user terminal in FIG. 8A in order to receive BGM source information in a member store. A user may make a query for or search for the member store to acquire the BGM source information. In FIG. 8B, the user inputs a member store number to make a query to the member store, on the menu for function selection. The member store number is made of member store identifiers to identify a member store that has joined a system for providing music source information, and may be made of consecutive numerals or characters, or a combination of the consecutive numerals and characters. In FIG. 8C, the user terminal displays the menu for function selection when the user inputs the member store number, that is, the member store identifier, the menu for function selection being capable of connecting to information about the member store such as a BGM list of BGM source information of the member store, location of the member store, transport information, and other related information. When the BGM list of the BGM source information of the member store is selected from FIG. 8C, a playlist of the BGM source information is displayed as the NGM source information in FIG. 8D. The playlist of the BGM source information may include a play order and a play time of a BGM source, a song title of the BGM source, an artist, album, and the like. As an example, in FIG. 8D, BGM source information such as a play time ranges from ‘10:05 to 10:09’, an artist is ‘Rain’, a song title is ‘I DO’, and an album title is ‘Stand Alone’ are displayed for a first play order. The user selects a BGM source of a required time period, among the playlist, and the user terminal supports the menu for function selection to receive related contents with respect to the BGM source. That is, the user selects ‘MENU’ of the menu for function selection, and is provided a menu for selection to receive the related contents with respect to the BGM source. The related contents may be any one of a BGM source file corresponding to the BGM source information, that is, download songs, data of ring sounds corresponding to the BGM source information, that is, download ring sounds, data of ring back tones corresponding to the BGM source information, that is, establish coloring, and data about artists corresponding to the BGM source information, that is, decorate a phone. Also, to download the related contents or to be provided contents related to configuration changes in the user terminal, the user terminal may be interoperated with a predetermined payment system, and the related contents may be provided to the user after the user has paid for the related contents.

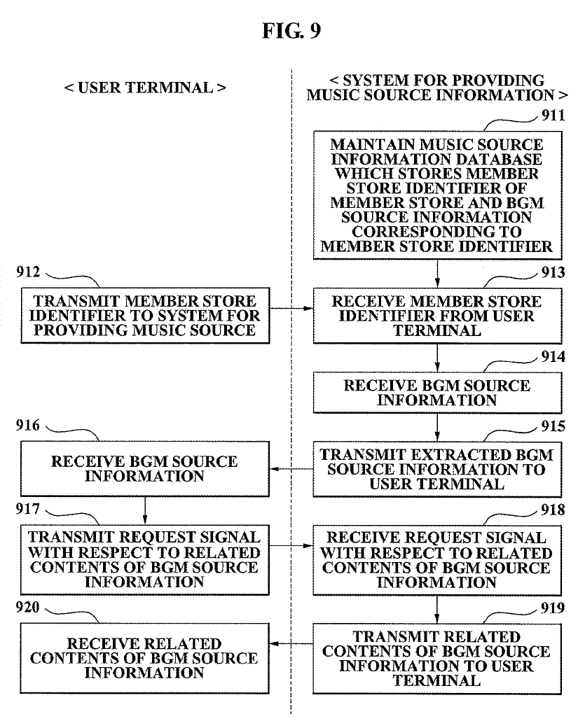

FIG. 9 is a flowchart illustrating a system for providing music source information which provides either a user terminal with BGM source information of a member store, or related contents with respect to the BGM source information, according to another exemplary embodiment of the present invention.

Referring to FIG. 9, the system for providing music source information maintains a music source information database which stores a member store identifier of the member store and the BGM source information corresponding to the member store identifier in operation 911. The user terminal transmits the member store identifier to the system for providing music source information in operation 912, and the system for providing music source information receives the member store identifier from the user terminal in operation 913. The system for providing music source information extracts BGM source information which corresponds to the member store identifier in operation 914, and transmits the extracted BGM source information to the user terminal in operation 915. The user terminal receives the BGM source information in operation 916. Through the above described operations, the BGM source information may be provided, from the system for providing music source information, to the user terminal.

In operation 917, the user terminal transmits a request signal with respect to related contents of the BGM source information to the system for providing music source information. The system for providing music source information receives the request signal with respect to related contents of the BGM source information in operation 918, and transmits the related contents of the BGM source information to the user terminal in operation 919. The user terminal receives the related contents with respect to the BGM source information in operation 920, thereby providing the related contents with respect to the BGM source information, from the system for providing music source information, to the user terminal.

The method for providing a service with respect to a BGM request and for providing a music source according to the above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. The media may also be a transmission medium such as optical or metallic lines, wave guides, etc. including a carrier wave transmitting signals specifying the program instructions, data structures, etc. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention.

According to the above-described exemplary embodiments of the present invention, it is possible to receive a member store identifier from a user, and to transmit BGM source information of a member store or related contents with respect to the BGM source information to the user terminal.

Also, according to the above-described exemplary embodiments of the present invention, it is possible to immediately respond to a query regarding a music source which is presently being listened to by a user in a member store by receiving BGM source information, which is being outputted to each member store in a real time streaming manner via a user terminal, and to simultaneously transmit related contents with respect to the BGM source information of the user terminal.

Also, according to the above-described exemplary embodiments of the present invention, it is possible to play a BGM source in a corresponding member store in a real time streaming manner by making a request for the BGM source via the user terminal.

Also, according to the above-described exemplary embodiments of the present invention, it is possible to make a request for a BGM source via a user terminal, and can play the BGM source in a real time streaming manner in a corresponding member store

Also, according to the above-described exemplary embodiments of the present invention, it is possible to produce a suitable ambience for each member store since a request for a BGM source is made via the user terminal for each member store, and the requested BGM source is received according to categories of the BGM source.

Also, according to the above-described exemplary embodiments of the present invention, it is possible to produce a suitable ambience according to a user's feeling since the user's required comment is inserted into a BGM source via the user terminal, and the BGM source selected by the user is listened to in a real time streaming manner) via an audio system in a member store

Also, according to the above-described exemplary embodiments of the present invention, it is possible to provide a differentiated ubiquitous service capable of connecting an online and an offline member store since a BGM source is requested via the user terminal, and the requested BGM source is played in a corresponding member store in a real time streaming manner.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method for providing a user terminal with music source information, the method comprising:
maintaining a music source information database which stores a member store identifier, with respect to at least one member store, and background music (BGM) source information which corresponds to the member store identifier, the BGM source information including playlist information of a BGM source to be played in the member store;
receiving the member store identifier from a user via a wired/wireless communication network;
reading the BGM source information which corresponds to the member store identifier by referring to the music source information; and
transmitting the BGM source information to the user terminal.

2. The method of claim 1, further comprising:
receiving a user's request for related contents service with respect to the transmitted BGM source information; and
providing the user terminal with the related content.

3. The method of claim 2, wherein the related contents is any one of a BGM source file corresponding to the BGM source information, data of ring sounds corresponding to the BGM source information, data of ring back tones corresponding to the BGM source information, and data about artists corresponding to the BGM source information.

4. The method of claim 2, wherein the providing the user terminal with the related contents provides address information to enable the related contents to be used in the user terminal.

5. The method of claim 1, wherein the wired/wireless communication network supports a Wireless Application Protocol (WAP) or the World Wide Web (WEB).

6. The method of claim 2, further comprising:
controlling a predetermined payment system to pay for the related contents when a purchase request for the related contents exists, from the user.

7. A method of providing a service with respect to a request for a BGM source, the method comprising:
maintaining a music source information database which stores a member store identifier, with respect to at least one member store, and BGM source information which corresponds to the member store identifier, the BGM source information including playlist information of a BGM source to be played in the member store;
receiving the member store identifier from a user terminal via a wired/wireless communication network;
receiving requested BGM source information;
updating the BGM source information stored in the music source information database according to the requested BGM source information.

8. The method of claim 7, wherein the receiving of the member store identifier from the user terminal via the wired/wireless communication network comprises:
reading the BGM source information which corresponds to the member store identifier by referring to the music source information database, and providing the user terminal with the BGM source information.

9. The method of claim 7, wherein the receiving of the BGM source information comprises:
receiving comment data to be inserted into the requested BGM source, from the user terminal, for the BGM source

10. The method of claim 9, wherein the comment data is text data, and further comprises converting the comment data to a speech file via a predetermined converter.

11. The method of claim 7, wherein the wired/wireless communication network supports a WAP or a WEB.

12. A method of providing a service with respect to a request for BGM source information, the method comprising:
receiving required BGM source information to play in a member store from at least one member store, and storing the BGM source information in a music source information database, the BGM source information including playlist information of the BGM source to play in the member store;
receiving the member store identifier from a user terminal via a wired/wireless communication network;
receiving requested BGM source information from the user terminal; and
updating the BGM source information stored in the music source information database according to the requested BGM source information.

13. The method of claim 12, wherein the receiving of the required BGM source information to play in the member store comprises:
receiving category information of the BGM source to play in the member store,
wherein the updating of the BGM source information stored in the music source information database comprises:
determining whether category information of the BGM source included in the requested BGM source information and the category information being received from the member store satisfy a predetermined condition; and
updating the music source information database when the predetermined condition is satisfied as a result of the determination.

14. A computer-readable storage medium storing a program for implementing a method for providing a user terminal with music source information, the method comprising:
maintaining a music source information database which stores a member store identifier, with respect to at least one member store, and background music (BGM) source information which corresponds to the member store identifier, the BGM source information including playlist information of a BGM source to be played in the member store;
receiving the member store identifier from a user terminal via a wired/wireless communication network;
reading the BGM source information which corresponds to the member store identifier by referring to the music source information; and
transmitting the BGM source information to the user terminal.

15. A system for providing a user terminal with music source information, the system comprising:
a music source information database storing a member store identifier, with respect to at least one member store, and BGM source information which corresponds to the member store identifier, the BGM source information including playlist information of a BGM source to be played in the member store;
a member store identifier receiving module receiving the member store identifier via a wired/wireless communication network from a user;
a music source information management module outputting the BGM source information which corresponds to the member store identifier by referring to the music source information database; and
a music source information transmission module transmitting the BGM source information to a user terminal.

16. The system of claim 15, further comprising:
a contents management module receiving a user's request for related contents with respect to the transmitted BGM source information;
a contents transmission module transmitting the related contents being transmitted from the user to the user terminal.

17. The system of claims 16, wherein the related contents is any one of a BGM source file corresponding to the BGM source information, data of ring sounds corresponding to the BGM source information, data of substituting ring back tones corresponding to the BGM source information, and data about artists corresponding to the BGM source information.

18. The system of claim 16, wherein the contents transmission module provides address information to enable the related contents to be used in the user terminal.

19. The system of claim 15, wherein the wired/wireless communication network supports a WAP or a WEB.

20. The system of claim 16, further comprising:
a payment control module controlling a predetermined payment system to pay for the related contents when a purchase request for the related contents exists, from the user.

21. A system for providing a service to play a BGM source in a real time streaming manner in a corresponding member store by making a request for the BGM source via a user terminal, the system comprising:
a music source information database storing a member store identifier, with respect to at least one member store, and BGM source information which corresponds to the member store identifier, the BGM source information including playlist information of the BGM source to be played in the member store;
a member store identifier management module receiving the member store identifier from a user via a wired/wireless communication network, and transmitting the member store identifier to the user terminal;
a music source information management module outputting the BGM source information which corresponds to the member store identifier by referring to the music source information, and transmitting the BGM source information to the user terminal; and
a music source selection providing module selecting the BGM source of a music source being required by the member store from the music source information database, and selecting a requested BGM source which is requested by a user.

22. The system of claim 21, further comprising:
a comment data receiving module receiving comment data to be inserted into the requested BGM source from the user terminal; and
a converter transmitting the comment data in a streaming manner, and converting the comment data to a speech file which is inserted to the requested BGM source.
